(19) United States
(12) Patent Application Publication
(10) Pub. No.: US 2010/0027780 A1
(43) Pub. Date: Feb. 4, 2010

(54) Systems and methods for anonymizing personally identifiable information associated with epigenetic information

(75) Inventors: Edward K.Y. Jung, Bellevue, WA (US); Roderick A. Hyde, Redmond, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(73) Assignee: Searete LLC, a limited liability corporation of the State of Delaware

(21) Appl. No.: 11/986,967

(22) Filed: Nov. 27, 2007

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.

(51) Int. Cl. H04L 9/28; G06F 17/30; H04L 9/00

(52) U.S. Cl. 380/28; 707/104.1; 707/E17.009; 380/277

(57) ABSTRACT

Methods and devices are described for anonymizing personally identifiable information associated with epigenetic information.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method includes receiving epigenetic information including but not limited to personalty identifying information and at least one epigenetic feature of interest associated with the personally identifying information for an individual. The personally identifying information may be obfuscated. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A system includes a means for receiving epigenetic information including but not limited to personalty identifying information and at least one epigenetic feature of interest associated with the personally identifying information for an individual. The system may further include a means for obfuscating the personally identifying information. In addition to the foregoing, other method aspects are described in the claims, drawings, and text forming a part of the present disclosure.

A system includes circuitry for receiving epigenetic information including but not limited to personally identifying information and at least one epigenetic feature of interest associated with the personally identifying information for an individual. The system may further include circuitry for obfuscating the personally identifying information. In addition to the foregoing, other method aspects are described in the claims, drawings, and text forming a part of the present disclosure.

The foregoing summary is illustrative only and is NOT intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A illustrates an exemplary environment in which one or more technologies may be implemented.

FIG. 1B illustrates an exemplary environment in which one or more technologies may be implemented.

FIG. 2 illustrates an operational flow representing example operations related to anonymizing personally identifiable information associated with epigenetic information.

FIG. 3 illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein.

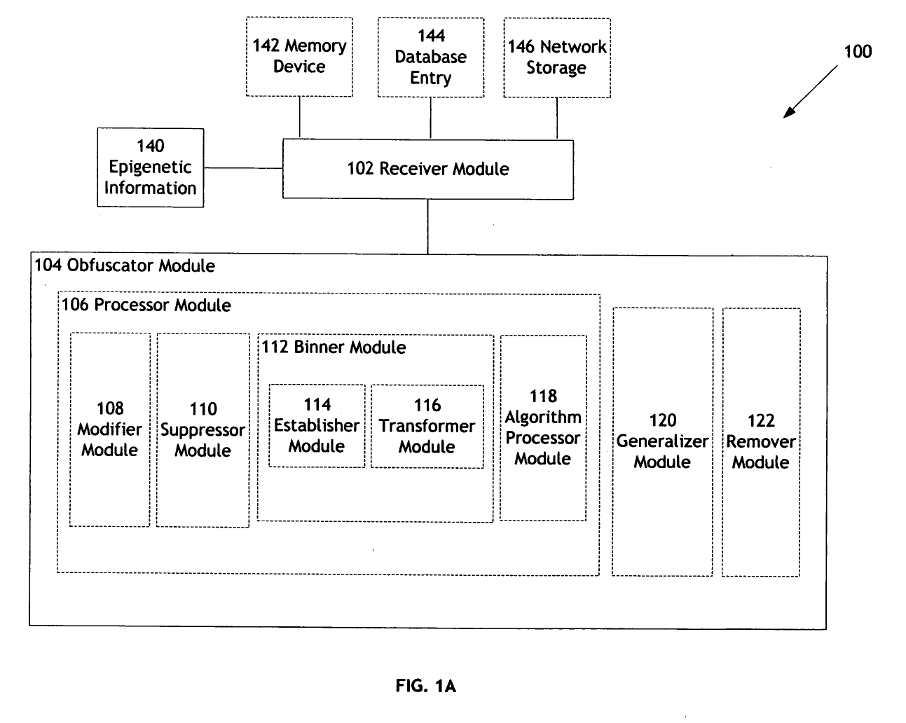

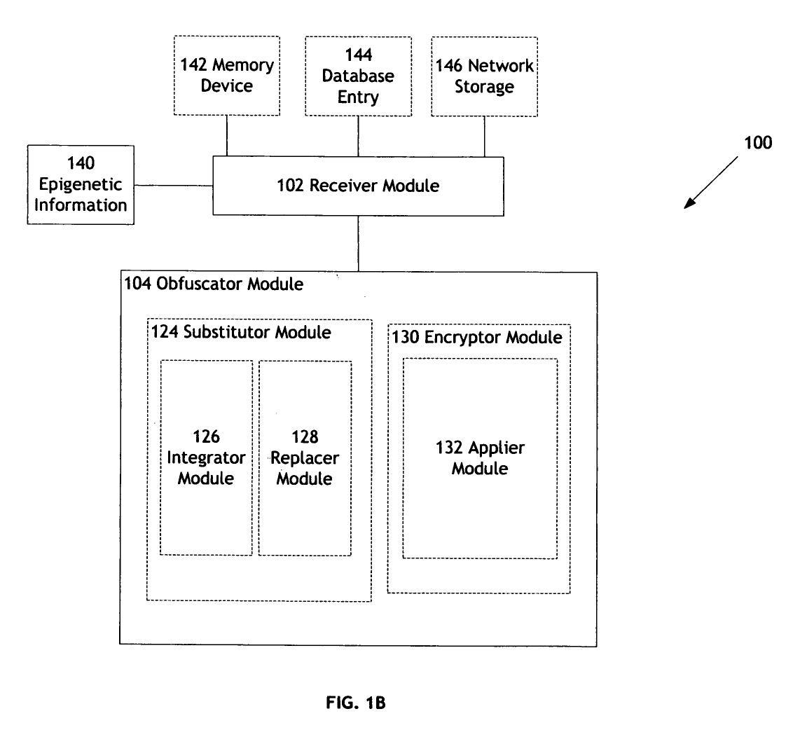

Referring to FIGS. 1A and 1B, a system 100 for anonymizing epigenetic information is illustrated. The system 100 may include receiver module 102 and/or obfuscator module 104. Receiver module 102 may receive epigenetic information 140. Obfuscator module 104 may further include processor module 106, generalizer module 120, remover module 122, substitutor module 124, and encryptor module 130. Processor module 106 may further include modifier module 108, suppressor module 110, binner module 112, and algorithm processor module 118. Binner module 112 may further include establisher module 114, and transformer module 116. Substitutor module 124 may further include integrator module 126 and replacer module 128. Encryptor module 130 may further include applier module 132. System 100 generally represents instrumentality for anonymizing epigenetic information. Anonymizing epigenetic information may be accomplished electronically, such as with a set of interconnected electrical components, an integrated circuit, and/or a computer processor.

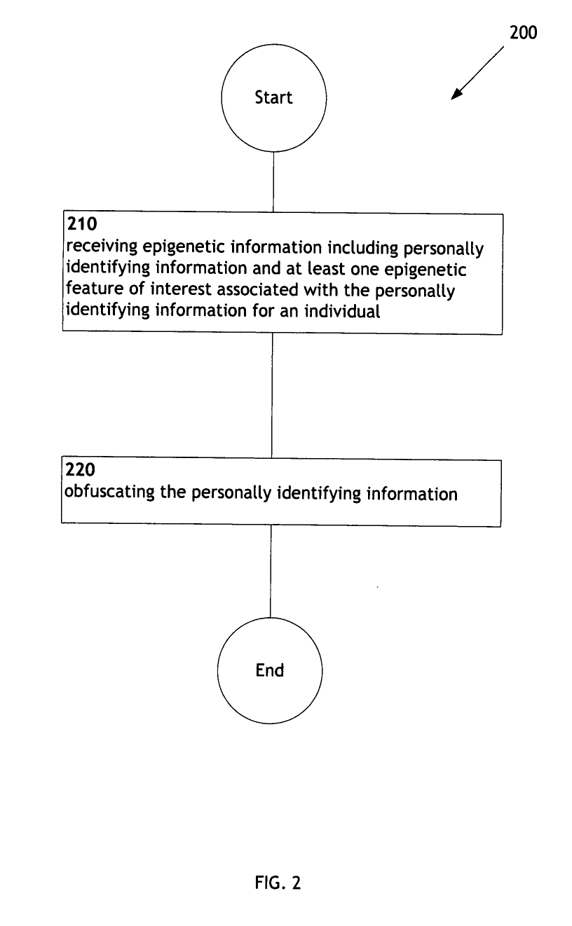

FIG. 2 illustrates an operational flow 200 representing example operations related to receiving epigenetic information including personally identifying information and at least one epigenetic feature of interest associated with the personally identifying information for an individual. In FIG. 2 and in following figures that include various examples of operational flows, discussion and explanation may be provided with respect to the above-described examples of FIGS. 1A and 1B, and/or with respect to other examples and contexts. However, it should be understood that the operational flows may be executed in a number of other environments and contexts, and/or in modified versions of FIGS. 1A and 1B. Also, although the various operational flows are presented in the sequence(s) illustrated, it should be understood that the various operations may be performed in other orders than those which are illustrated, or may be performed concurrently.

After a start operation, the operational flow 200 moves to a receiving operation 210, where epigenetic information including personally identifying information and at least one epigenetic feature of interest associated with the personally identifying information may be received for an individual. For example, as shown in FIG. 1A, system 100 may include receiver module 102 for receiving epigenetic information. In one implementation, receiver module 102 may receive from network storage 146 epigenetic information including personally identifying information and at least one epigenetic feature of interest associated with the personally identifying information. Personally identifying information may include a name, an address, a telephone number, a social security number, an ethnicity and/or any piece of information which may potentially be used to uniquely identify, contact, and/or locate at least one person. An example of personally identifying information associated with epigenetic information may include a name corresponding to a specific methylation status indicating a predetermined condition. In some instances, receiver module 102 may include a computer processor. Some explanation regarding epigenetic information may be found in sources such as Bird, Perceptions of Epigenetics, NATURE 477, 396-398 (2007); Grewal and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R101 (2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., Valinluck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference.

Then, in an obfuscating operation 220, the personally identifying information may be obfuscated. For example, as shown in FIG. 1A, system 100 may include obfuscator module 104 for obfuscating personally identifying information corresponding with received epigenetic information. Continuing with the previous example, receiver module 102 may receive from a network storage 146 epigenetic information including personally identifying information and at least one epigenetic feature of interest associated with the personally identifying information; accordingly, obfuscator module 104 may obfuscate and/or make unclear the personally identifying information received with the epigenetic information, such as removing a name associated with the epigenetic feature of interest. In some instances, obfuscator module 104 may include a computer processor.

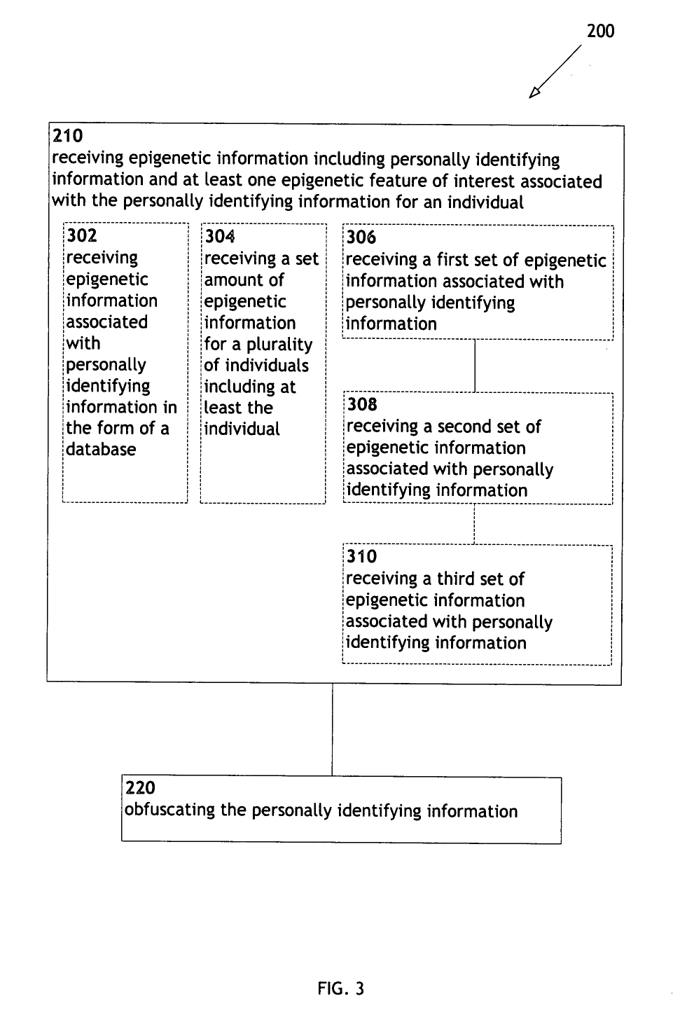

FIG. 3 illustrates alternative embodiments of the example operational flow 200 of FIG. 2. FIG. 3 illustrates example embodiments where the receiving operation 210 may include at least one additional operation. Additional operations may include an operation 302, an operation 304, an operation 306, an operation 308, and/or an operation 310.

At the operation 302, epigenetic information associated with personally identifying information in the form of a database may be received. For example, as shown in FIG. 1A, receiver module 102 may receive epigenetic information in the form of a database. In a specific instance, receiver module 102 receives epigenetic information in the form of a database from network storage 146. A database may include a collection of data organized for convenient access. The database may include information digitally stored in a memory device 142, as at least a portion of at least one database entry 144, and/or in network storage 146. In some instances, the database may include information stored non-digitally such as at least a portion of a book, a paper file, and/or a non-computerized index and/or catalog. Non-computerized information may be received by receiver module 102 by scanning or manually entering the information into a digital format. In some instances, receiver module 102 may include a computer processor.

At the operation 304, a set amount of epigenetic information for a plurality of individuals including at least one individual may be received. For example, as shown in FIG. 1A, receiver module 102 may receive from a memory device 142 a set of epigenetic information for a plurality of individuals, such as individuals in a predetermined population categorized by geographic residence. A set may include batch, finite, and/or discrete amounts of epigenetic information associated with personally identifying information.

At the operation 306, a first set of epigenetic information associated with personally identifying information may be received. For example, as shown in FIG. 1A, receiver module 102 may receive from a memory device 142 a first set of epigenetic information for a plurality of individuals, such as individuals in a predetermined population categorized by geographic residence, in the form of a batch of epigenetic information associated with personally identifying information. Then, at the optional operation 308, a second set of epigenetic information associated with personally identifying information may be received. For example, as shown in FIG. 1A, and continuing from the previous example, receiver module 102 may receive from a memory device 142 a second batch of epigenetic information associated with personally identifying information. The second set of epigenetic information may include information collected and/or obtained subsequently to the collection of the first set of information. Further, at the operation 310, a third set of epigenetic information associated with personally identifying information may be received. For example, as shown in FIG. 1A, and continuing from the previous example, receiver module 102 may receive from a memory device 142 a third batch of epigenetic information associated with personally identifying information. The third set of epigenetic information may include information collected and/or obtained in addition to the collection of the second set of information. In a specific example, receiver module 102 receives a third batch of epigenetic information regarding a specific DNA methylation indicating a likelihood of heart disease for a group of fifty people. Additional sets of information may be received by receiver module 102 as batches or finite sets beyond the first, second, and third set of epigenetic information. In some instances, receiver module 102 may include a computer processor.

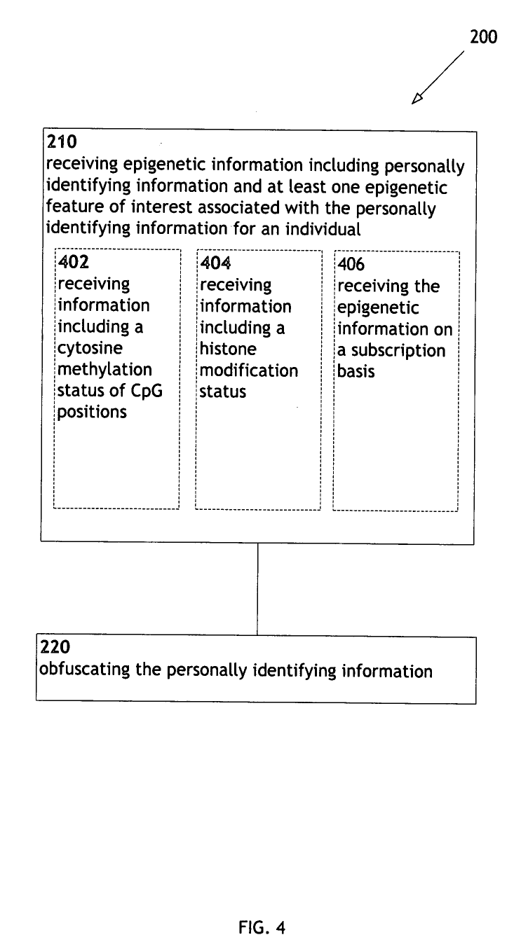

FIG. 4 illustrates alternative embodiments of the example operational flow 200 of FIG. 2. FIG. 4 illustrates example embodiments where the receiving operation 210 may include at least one additional operation. Additional operations may include an operation 402, an operation 404, and/or an operation 406.

At the operation 402, information including a cytosine methylation status of CpG positions may be received. For example, as shown in FIG. 1A, receiver module 102 may receive from memory device 142 epigenetic information associated with personally identifying information including a cytosine methylation status of CpG positions. Receiver module 102 may include a computer processor. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference.

At the operation 404, information including a histone modification status may be received. For example, as shown in FIG. 1A, receiver module 102 may receive from memory device 142 epigenetic information associated with personally identifying information including an indication of histone modification status. Receiver module 102 may include a computer processor. For example, receiving information regarding histone structure may include information regarding histone structure generally or in the aggregate, or histone structure at one or more specific locations, including one or more chromosomes. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference.

At the operation 406, epigenetic information on a subscription basis may be received. For example, as shown in FIG. 1A, the receiver module 102 may receive from network storage 146 epigenetic information associated with personally identifying information on a subscription basis. In some instances, receiver module 102 may include a computer processor. A subscription may include a transaction wherein a party purchases access to a product and/or service for a period of time. For example, an insurance underwriter may purchase access to a database including epigenetic information associated with personally identifying information for one year for five thousand dollars. Additionally, a subscription may include different rates for different information, such a higher rate for more specific information compared to a lower rate for more general information. In some instances, receiver module 102 may include a computer processor.

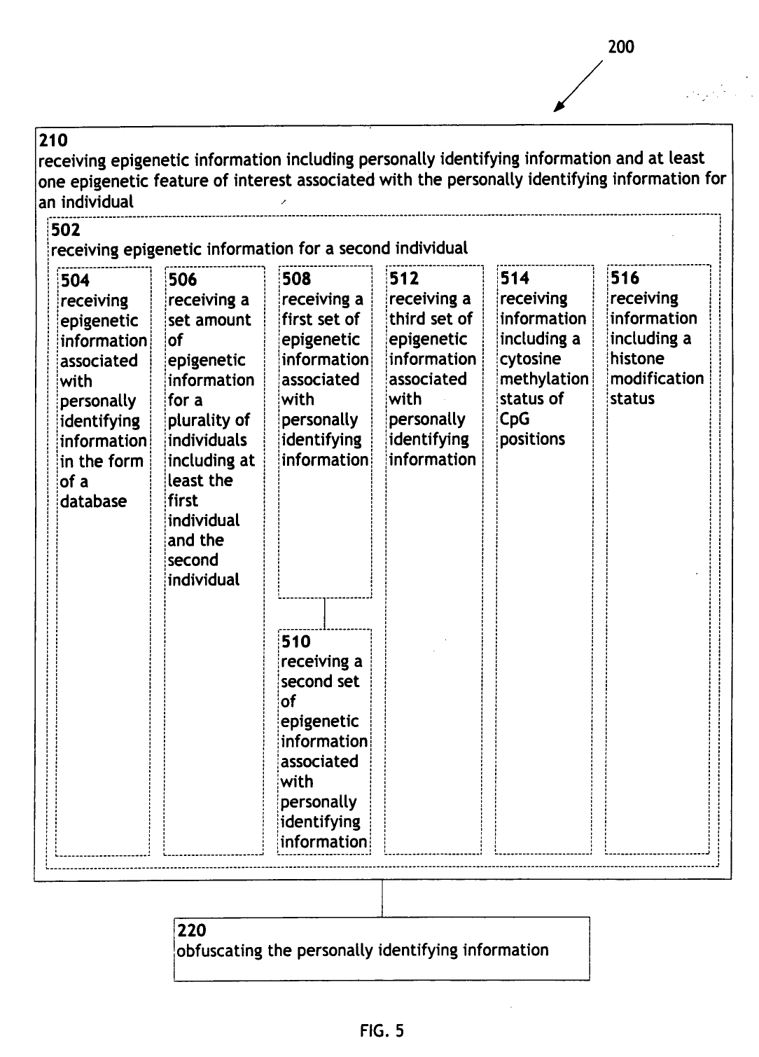

FIG. 5 illustrates alternative embodiments of the example operational flow 200 of FIG. 2. FIG. 5 illustrates example embodiments where receiving operation 210 may include at least one additional operation. Additional operations may include an operation 502, an operation 504, an operation 506, an operation 508, an operation 510, an operation 512, an operation 514, and/or an operation 516.

At the operation 502, epigenetic information for a second individual may be received. For example, as shown in FIG. 1A, receiver module 102 may receive epigenetic information associated with personally identifying information for at least one person and a second person. In one specific instance, receiver module 102 receives epigenetic information associated with personally identifying information for John Smith and David Smith. Names used herein are meant to be exemplary only. In some instances, receiver module 102 may include a computer processor. Further, at the operation 504, epigenetic information associated with personally identifying information in the form of a database may be received. For example, as shown in FIG. 1A, the receiver module 102 may receive epigenetic information associated with personally identifying information for John Smith and David Smith in the form of a database. As discussed above, a database may include a collection of data organized for convenient access. The database may include information digitally stored in a memory device 142, as at least a portion of at least one database entry 144, and/or in network storage 146. In some instances, the database may include information stored non-digitally such as at least a portion of a book, a paper file, and/or a non-computerized index and/or catalog. Non-computerized information may be received by receiver module 102 by scanning or manually entering the information into a digital format. In some instances, receiver module 102 may include a computer processor.

Further, at the operation 506, a set amount of epigenetic information for a plurality of individuals including at least the first individual and the second individual is received. For example, as shown in FIG. 1A, receiver module 102 may receive a set amount of epigenetic information for at least a first individual and a second individual. In a specific instance, receiver module 102 receives from network storage 146 information related to DNA methylation for John Smith, David Johnson, and five thousand other people. In some instances, receiver module 102 may include a computer processor. Further, at the operation 508, a first set of epigenetic information associated with personally identifying information may be received. For example, as shown in FIG. 1A, receiver module 102 may receive a first set of epigenetic information associated with personally identifying information. In one specific instance, receiver module 102 may receive a first set of epigenetic information relating to a histone modification linked with names in the set of epigenetic information. In some instances, receiver module 102 may include a computer processor. Then, at the operation 510, a second set of epigenetic information associated with personally identifying information may be received. For example, as shown in FIG. 1A, receiver module 102 may receive a second set of epigenetic information associated with personally identifying information from a memory device 142. In one specific example, receiver module 102 may receive a first batch of information indicating a specific histone structure for a specific chromosome and a second batch of information indicating a specific DNA methylation for a group of five hundred life insurance candidates that volunteered epigenetic information. In some instances, receiver module 102 may include a computer processor. Further, at the operation 512, a third set of epigenetic information associated with personally identifying information may be received. For example, as shown in FIG. 1A, receiver module 102 may receive a third set of epigenetic information associated with personally identifying information from network storage 146. In one specific instance, receiver module 102 receives a third set of epigenetic information relating to the occurrence of a DNA methylation at a specific DNA base associated with social security numbers of the associated persons. In some instances, a receiver module 102 may include a data processor. Further, at the operation 514, information including a cytosine methylation status of CpG positions may be received. For example, as shown in FIG. 1A, receiver module 102 may receive epigenetic information including a cytosine methylation status of CpG positions associated with personally identifying information from a database entry 144. Receiver module 102 may include a computer processor and/or data processor. Further, at the operation 516, information including a histone modification status may be received. For example, as shown in FIG. 1A, receiver module 102 may receive epigenetic information including a histone modification status associated with personally identifying information from a database entry 144. In a specific occurrence, receiver module 102 may receive epigenetic information including a histone modification status related to the H2A histone class associated with personally identifying information including ethnicity from a database entry 144. In some occurrences, a receiver module 102 may include a computer processor.

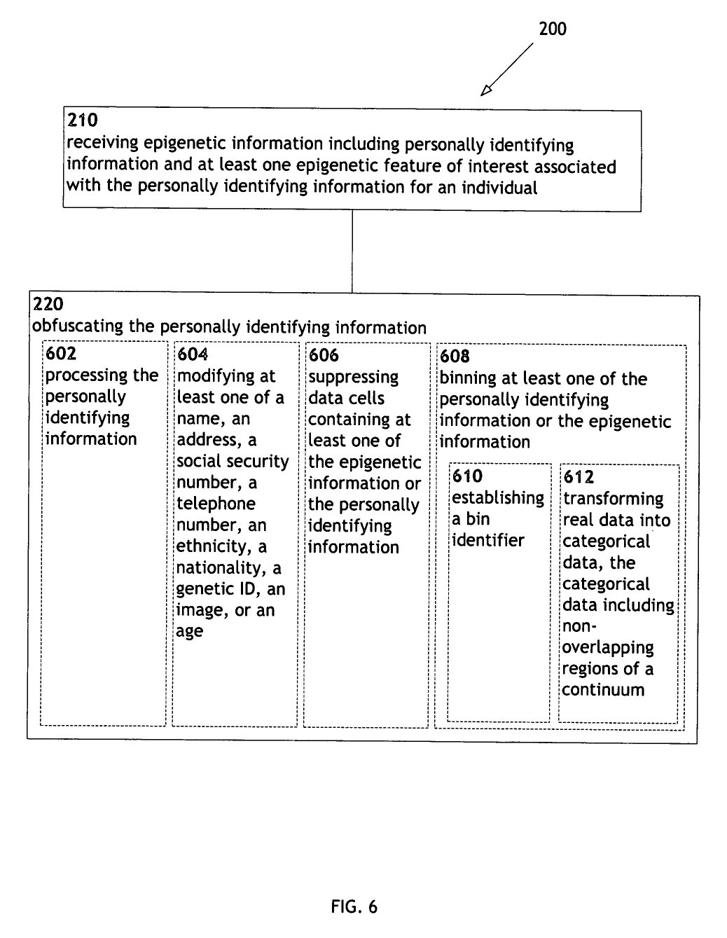

FIG. 6 illustrates alternative embodiments of the example operational flow 200 of FIG. 2. FIG. 6 illustrates example embodiments where the obfuscating operation 220 may include at least one additional operation. Additional operations may include an operation 602, an operation 604, an operation 606, an operation 608, an operation 610, and/or an operation 612.

At the operation 602, the personally identifying information may be processed. For example, as shown in FIG. 1A, processor module 106 may handle personally identifying information associated with epigenetic information by processing the personally identifying information. In one specific instance, processor module 106 handles a name associated with epigenetic information relating to methylation of a specific DNA base indicating a likelihood for cancer. In some instances, a processor module 106 may include a computer processor. Further, at the operation 604, at least one of a name, an address, a social security number, a telephone number, an ethnicity, a nationality, a genetic ID, an image, or an age may be modified. For example, as shown in FIG. 1A, modifier module 108 may change a name, an address, a social security number, a telephone number, an ethnicity, a nationality, a genetic ID, an image, and/or an age. A change may include removal, modification, and/or deletion of the personally identifying information. In one specific instance, modifier module 108 changes a genetic ID and an age associated with epigenetic information relating to a specific histone structure indication a probability of heart disease. In some occurrences, modifier module 108 may include a computer processor and/or a data processor. Further, at the operation 606, data cells containing at least one of the epigenetic information or the personally identifying information may be suppressed. For example, as shown in FIG. 1A, suppressor module 110 may withhold personally identifying information and/or epigenetic information. Withholding may include hiding and/or deleting the personally identifying information. In a specific instance, suppressor module 110 withholds personally identifying information by withholding a specific column of information in a database spreadsheet containing names that correspond to epigenetic information regarding a specific DNA methylation indicating a likelihood of diabetes. Suppression may include withholding information from disclosure and/or deleting information. Suppression may further include cell suppression, such as the deletion of at least one predetermined cell in information included in a spreadsheet. In some occurrences, suppressor module 110 may include a computer processor. Further, at the operation 608, at least one of the personally identifying information or the epigenetic information may be binned. For example, as shown in FIG. 1A, binner module 112 may separate and/or bin personally identifying information according to age. Binning may include converting continuous data to discrete data by replacing a value from a continuous range with a bin identifier, where each bin represents a range of values. Personally identifying information may be binned utilizing a variety of values including age, geographic location, and/or social security numbers, as well as other values. In some instances, a binner module 112 may include a data processor and/or a computer processor. Further, at the operation 610, a bin identifier may be established. For example, as shown in FIG. 1A, establisher module 114 may set bin identifiers. In a specific instance, establisher module 114 sets bin identifiers for separating information by age as 20, 35, 65, and 80. A bin identifier may include a bin boundary. A bin boundary may have a start and an end. The end value of the bin boundary may be greater than or equal to the start value. The low value of the bin boundary may be included in the bin, and the high value may be excluded, except for the bin with the largest high value. In some instances, establisher module 114 may include a computer processor. Further, at the operation 612, real data may be transformed into categorical data including non-overlapping regions of a continuum. For example, as shown in FIG. 1A, transformer module 116 may convert personally identifying information into categorical and/or discrete data including non-overlapping regions of a continuum. In a specific example, establisher module 114 converts personally identifying information into groups of information according to location by utilizing a ZIP code corresponding to the location. In the same example, the personally identifying information is converted into non-overlapping regions of a continuum utilizing the bin identifiers 00000, 20000, 40000, 60000, 80000, and 99999. In some instances, establisher module 114 may include a computer processor.

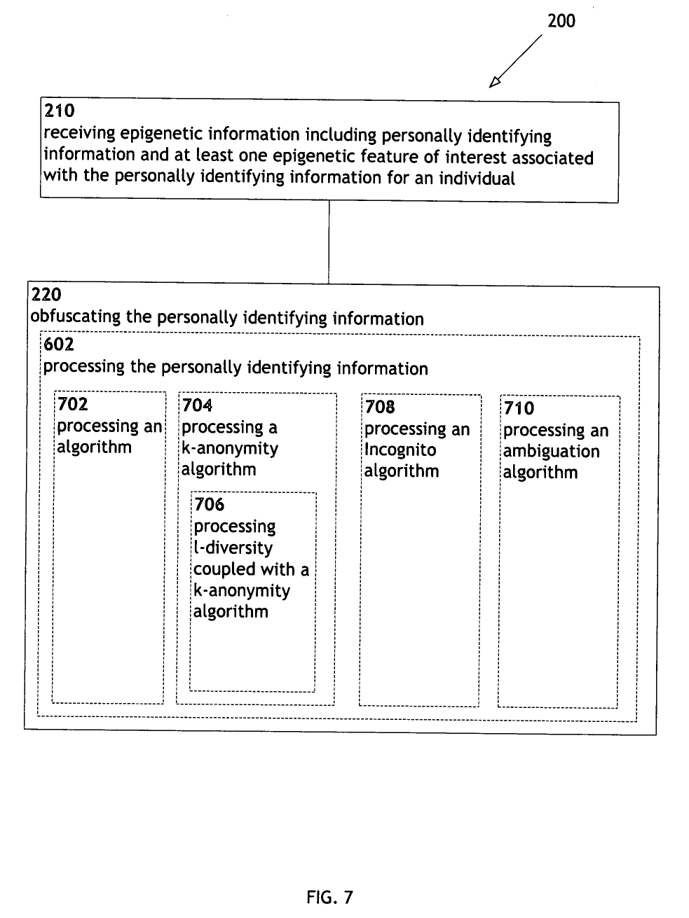

FIG. 7 illustrates alternative embodiments of the example operational flow 200 of FIG. 2. FIG. 7 illustrates example embodiments where the obfuscating operation 220 may include at least one additional operation. Additional operations may include an operation 702, an operation 704, an operation 706, an operation 708, and/or an operation 710. Further, at the operation 702, an algorithm may be processed. For example, as shown in FIG. 1A, algorithm processor module 118 may execute an algorithm. In a specific instance, algorithm processor module 118 executes an algorithm for anonymizing and/or obfuscating personally identifying information associated with epigenetic information. Algorithm processor module 118 may execute a wide variety of algorithms including Samarati's algorithm, Bayardo-Agrawal's algorithm, an Incognito algorithm, and/or Heuristic algorithms, as well as other algorithms. In some instances, algorithm processor module 118 may include a computer processor. Further, at the operation 704, a k-anonymity algorithm may be processed. For example, as shown in FIG. 1A, algorithm processor module 118 may execute and/or process a k-anonymity algorithm. A k-anonymity algorithm may include an algorithm that demands every tuple, or a finite sequence of objects, in a table of released information to be indistinguishably related to no fewer than k respondents. A k-anonymity algorithm may require that, in a released amount of information, the respondents be indistinguishable within a given set with respect to the set of attributes. Additionally, a k-anonymity algorithm may utilize other techniques such as generalization and suppression. In some instances, algorithm processor module 106 may include a computer processor. Further, at the operation 706, l-diversity coupled with a k-anonymity algorithm may be processed. For example, as shown in FIG. 1A, algorithm processor module 106 may execute an l-diversity coupled with a k-anonymity algorithm for anonymizing personally identifying information associated with epigenetic information. In a specific instance, algorithm processor module 106 executes an l-diversity coupled with a k-anonymity algorithm for anonymizing a name and a social security number associated with information relating to the histone structure of a specific chromosome indicating a positive likelihood of obesity. A block of information in a table may be l-diverse if it contains at least l different values for a sensitive attribute. A background knowledge attack may be more complicated for a greater l because more knowledge may be needed for individualizing a unique value. A k-anonymity algorithm utilizing l-diversity may add further complexity to anonymization of personally identifying information associated with epigenetic information. In some instances, algorithm processor module 106 may include a computer processor. Further, at the operation 708, an Incognito algorithm may be processed. For example, as shown in FIG. 1A, algorithm processor module 106 may execute an Incognito algorithm. In a specific example, algorithm processor module 106 executes an Incognito algorithm for anonymizing a name and an address associated with information relating to the DNA methylation at a specific DNA base indicating a positive likelihood of cancer. An Incognito algorithm may find all k-anonymous full-domain generalizations by checking k-anonymity with respect to single-attribute subsets of a quasi-identifier. Subsequently, the Incognito algorithm may iteratively check larger subsets of quasi-identifiers. An Incognito algorithm may utilize a bottom-up breadth-first search on the domain generalization hierarchy and may exclude some generalizations in advance from the hierarchy in a priori computation. In some instances, algorithm processor module 106 may include a computer processor. Further, at the operation 710, an ambiguation algorithm may be processed. For example, as shown in FIG. 1A, algorithm processor module 106 may execute an ambiguation algorithm for anonymizing personally identifying information associated with epigenetic information. An ambiguation algorithm may include algorithms that make personally identifying information associated with epigenetic information undefined, undefinable, and/or without an obvious definition and thus having an unclear meaning. In a specific example, algorithm processor module 106 executes an ambiguation algorithm for anonymizing a genetic ID associated with information relating to a specific DNA methylation at a specific DNA location indicating a positive likelihood of diabetes. In some situations, algorithm processor module 106 may include a computer processor.

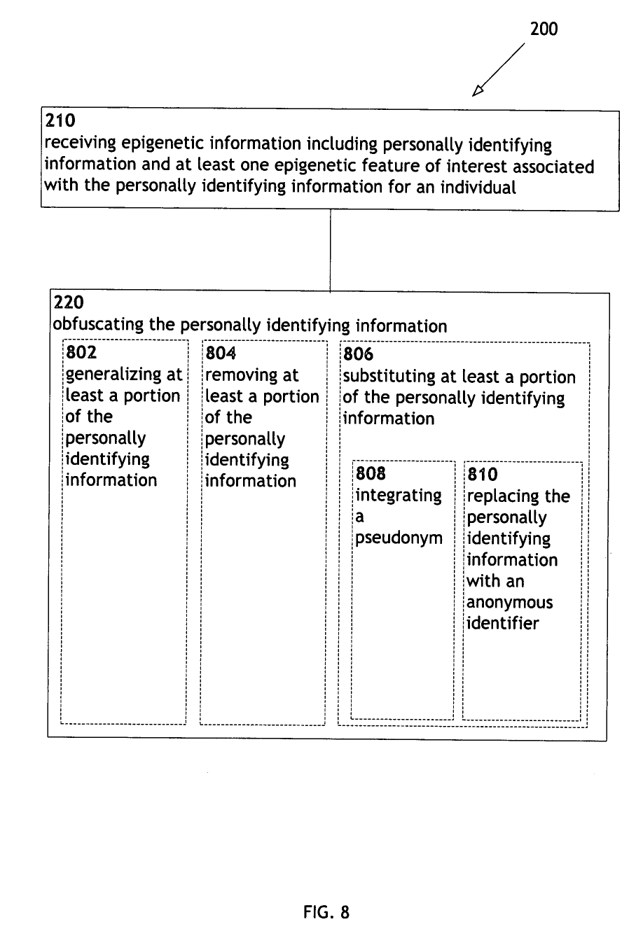

FIG. 8 illustrates alternative embodiments of the example operational flow 200 of FIG. 2. FIG. 8 illustrates example embodiments where the obfuscating operation 220 may include at least one additional operation. Additional operations may include an operation 802, an operation 804, an operation 806, an operation 808, and/or an operation 810.

At the operation 802, at least a portion of the personally identifying information may be generalized. For example, as shown in FIG. 1A, generalizer module 120 may alter the personally identifying information associated with epigenetic information. Generalizing the information may include substituting values of a given attribute with values that are more general. One advantage to generalization may include preservation of the truthfulness of the information. In one instance, generalizer module 120 alters a table of information by deleting at least one digit of a ZIP code associated with epigenetic information. In the same instance, a postal address may be generalized to a street, a city, a region, and/or a state depending on the number of digits of a ZIP code that are deleted. In some occurrences, generalizer module 120 may include a data processor and/or a computer processor.

At the operation 804, at least a portion of the personally identifying information may be removed. For example, as shown in FIG. 1A, remover module 122 may delete at least a portion of personally identifying information associated with epigenetic information. In one instance, remover module 122 deletes a social security number and a name corresponding to information regarding a histone structure that indicates a likelihood of cancer. In some situations, a remover module 122 may include a data processor and/or a computer processor.

At the operation 806, at least a portion of the personally identifying information may be substituted. For example, as shown in FIG. 1B, substitutor module 124 may replace personally identifying information associated with epigenetic information with other information. In a specific example, substitutor module 124 replaces a name associated with information related to a specific DNA methylation indicating heart disease with a randomly assigned number. In some instances, substitutor module 124 may include a computer processor. Further, at the operation 808, a pseudonym may be integrated. For example, as shown in FIG. 1B, integrator module 126 may incorporate a pseudonym into personally identifying information associated with epigenetic information. A pseudonym, also known as an alias, may include an artificial and/or fictitious name utilized by an individual as an alternative to the individual's true name. In one specific instance, integrator module 126 incorporates a pseudonym as a part of personally identifying information associated with epigenetic information. In the same instance, the pseudonym is a randomly assigned number. A pseudonym may include a number, a name, a maiden name, and/or some other symbol. In some situations, integrator module 126 may include a computer processor. Further, at the operation 810, the personally identifying information with an anonymous identifier may be replaced. For example, as shown in FIG. 1B, replacer module 128 may change at least a portion of personally identifying information with an anonymous identifier. An anonymous identifier may be generated by an encryption device and/or may be an assigned random number. In one specific instance, replacer module 128 changes a name in personally identifying information associated with epigenetic information with an anonymous identifier that is a random number. In some instances, a replacer module 128 may include a computer processor.

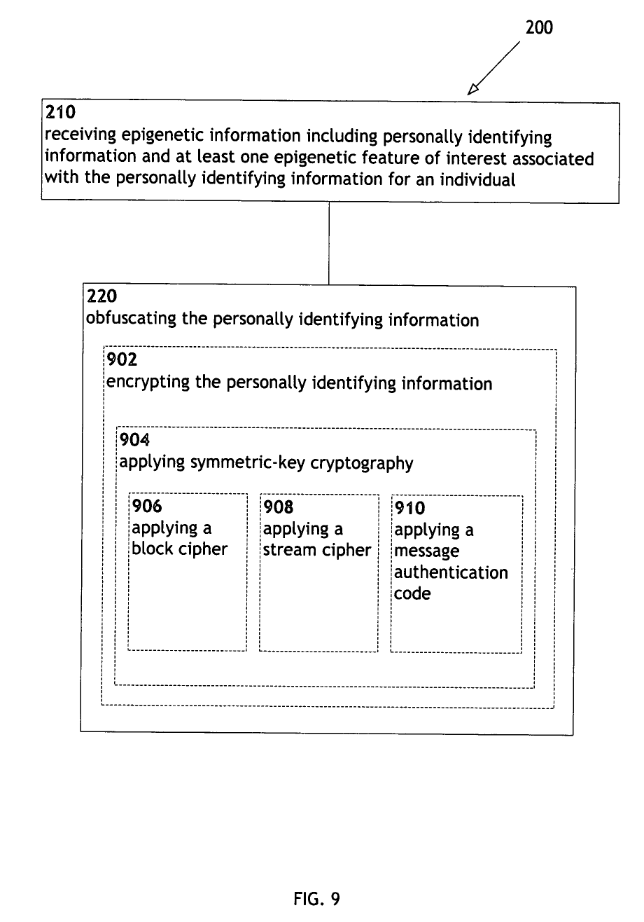

FIG. 9 illustrates alternative embodiments of the example operational flow 200 of FIG. 2. FIG. 9 illustrates example embodiments where the obfuscating operation 220 may include at least one additional operation. Additional operations may include an operation 902, an operation 904, an operation 906, an operation 908, and/or an operation 910.

At the operation 902, the personally identifying information may be encrypted. For example, as shown in FIG. 1B, encryptor module 130 may encipher personally identifying information associated with epigenetic information. In one specific instance, encryptor module 130 enciphers a name, a social security number, and a geographic location associated with information relating to a specific chromatin modification indicating a likelihood of hypertension. In some instances, encryptor module 130 may include a computer processor, a rotor machine, and/or an electromechanical machine. Further, at the operation 904, symmetric-key cryptography may be applied. For example, as shown in FIG. 1B, applier module 132 may utilize symmetric-key cryptography for encrypting personally identifying information. In one instance, applier module 132 utilizes symmetric-key cryptography to cipher a name as a part of personally identifying information associated with DNA methylation indicating a risk of heart attack. Symmetric-key cryptography may include encryption methods in which both a sender and a receiver receive the same key. A key may refer to a secret algorithm and/or parameter for a specific message context. In some instances, applier module 132 may include a computer processor. Further, at the operation 906, a block cipher may be applied. For example, as shown in FIG. 1B, applier module 132 may utilize a block cipher for encrypting personally identifying information. In one instance, applier module 132 utilizes a block cipher for encrypting a name and an address associated with information regarding a specific histone structure indicating likelihood for dementia. A block cipher may take a plaintext key as an input and output a block of ciphertext of the same size. Some block cipher designs may include the Data Encryption Standard and/or the Advanced Encryption Standard. In some instances, applier module 132 may include a computer processor. Further, at the operation 908, a stream cipher may be applied. For example, as shown in FIG. 1B, applier module 132 may utilize a stream cipher for encrypting personally identifying information associated with epigenetic information. In a specific example, applier module 132 utilizes a stream cipher for encrypting a name, an address, a telephone number, and a ZIP code associated with information relating to DNA methylation at a specific DNA site indication likelihood for muscular dystrophy. A stream cipher may create an arbitrarily long stream of key material combined with the plaintext bit-by-bit or character-by-character. The output stream of a stream cipher may be based on an internal state which changes as the cipher operates. With a stream cipher, the plaintext digits may be encrypted one at a time, and the transformation of successive digits may vary during the encryption. A stream cipher may include a synchronous stream cipher and/or a self-synchronizing stream cipher. In some instances, applier module 132 may include a computer processor. Further, at the operation 910, a message authentication code may be applied. For example, as shown in FIG. 1B, applier module 132 may execute a message authentication code for encrypting personally identifying information associated with epigenetic information. In one instance, applier module 132 executes a message authentication code for encrypting a name and an ethnicity associated with a histone structure status indicating likelihood for Parkinson's disease. A message authentication code may include an algorithm that accepts a secret key and an arbitrary-length message as an input to be authenticated, and outputs a message authentication code. In some instances, applier module 132 may include a computer processor.

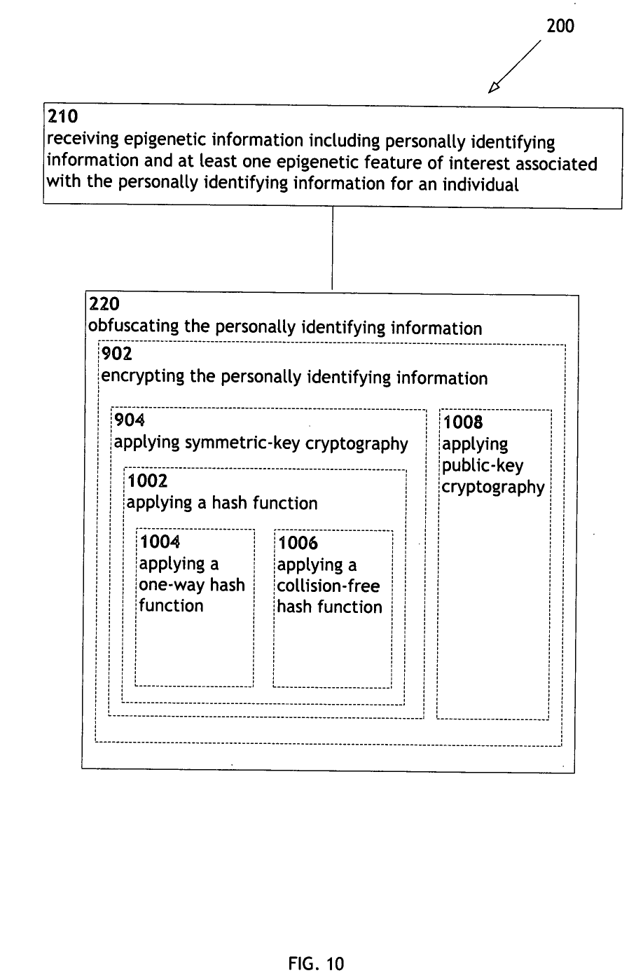

FIG. 10 illustrates alternative embodiments of the example operational flow 200 of FIG. 2. FIG. 10 illustrates example embodiments where the obfuscating operation 210 may include at least one additional operation. Additional operations may include an operation 1002, an operation 1004, an operation 1006, and/or an operation 1008.

At the operation 1002, a hash function may be applied. For example, as shown in FIG. 1B, applier module 132 may execute a hash function for obfuscating personally identifying information associated with epigenetic information. In one instance, applier module 132 executes a hash function for encrypting and/or anonymizing a name associated with information related to a specific chromatin modification indicating a probability for kidney failure. A hash function may include a reproducible method for turning data into a number and may serve as a digital fingerprint of the data. A hash function may substitute and/or transpose data to create a digital fingerprint and may be deterministic. Hash functions often have an infinite domain and a finite range. In some instances, applier module 132 may include a computer processor. Further, at the operation 1004, a one-way hash function may be applied. For example, as shown in FIG. 1B, applier module 132 may execute a one-way hash function for obfuscating personally identifying information associated with epigenetic information. In a specific instance, applier module 132 executes a one-way hash function for obfuscating a name associated with a specific DNA methylation indicating likelihood for developing Huntington's disease. In some instances, applier module 132 may include a data processor and/or a computer processor. Further, at the operation 1006, a collision-free hash function may be applied. For example, as shown in FIG. 1B, applier module 132 may execute a collision-free hash function for obfuscating personally identifying information associated with epigenetic information. In one instance, applier module 132 executes a collision-free hash function for obfuscating a name associated with information relating to a specific ubiquitylation of a histone indicating a probability of heart disease. A hash collision may include a situation in which two distinct inputs into a hash function produce identical outputs. A collision-free hash function may include an application where a small number of possible inputs are known beforehand. Additionally, a coltision-free hash function may include a hash function in which it is computationatly infeasible to find a collision. In some instances, applier module 132 may include a computer processor. Further, at the operation 1008, public-key cryptography may be applied. For example, as shown in FIG. 1B, applier module 132 may execute public-key cryptography for obfuscating personally identifying information associated with epigenetic information. In one example, applier module 132 executes public-key cryptography for obfuscating a name and a phone number associated with a specific acetylation of a histone structure. In public-key cryptography, two different but mathematically related keys, a public key and a private key, may be used. A public-key system may be constructed so that calculation of the private key is computationally infeasible from calculation of the public key. A public key may be utilized for encryption and freely distributed while a private key may be utilized for decryption and kept confidential. In some instances, applier module 132 may include a computer processor.

Those having skill in the art wilt recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
receiving epigenetic information including personally identifying information and at least one epigenetic feature of interest associated with the personally identifying information for an individual; and
obfuscating the personally identifying information.

2-40. (canceled)

41. A system comprising:
means for receiving epigenetic information including personally identifying information and at least one epigenetic feature of interest associated with the personally identifying information for an individual; and
means for obfuscating the personally identifying information.

42. The system of claim 41, wherein means for receiving epigenetic information including personally identifying information and at least one epigenetic feature of interest associated with the personally identifying information for an individual comprises:
means for receiving the epigenetic information in the form of a database.

43. The system of claim 41, wherein means for receiving epigenetic information including personally identifying information and at least one epigenetic feature of interest associated with the personally identifying information for an individual comprises:
means for receiving a set amount of the epigenetic information for a plurality of individuals including at least the individual.

44. The system of claim 41, wherein means for receiving epigenetic information including personally identifying information and at least one epigenetic feature of interest associated with the personally identifying information for an individual comprises:
means for receiving a first set of the epigenetic information associated with the personally identifying information; and
means for receiving a second set of the epigenetic information associated with the personally identifying information.

45. The system of claim 44, further comprising:
means for receiving a third set of the epigenetic information associated with the personally identifying information.

46. The system of claim 41, wherein means for receiving epigenetic information including personally identifying information and at least one epigenetic feature of interest associated with the personally identifying information for an individual comprises:
means for receiving information including a cytosine methylation status of CpG positions.

47. The system of claim 41, wherein means for receiving epigenetic information including personally identifying information and at least one epigenetic feature of interest associated with the personally identifying information for an individual comprises:
means for receiving information including a histone modification status.

48. The system of claim 41, wherein means for receiving epigenetic information including personally identifying information and at least one epigenetic feature of interest associated with the personally identifying information for an individual comprises:
means for receiving the epigenetic information for a second individual.

49. The system of claim 48, wherein means for receiving the epigenetic information for a second individual comprises:
means for receiving the epigenetic information in the form of a database.

50. The system of claim 48, wherein means for receiving the epigenetic information for a second individual comprises:
means for receiving a set amount of epigenetic information for a plurality of individuals including at least the first individual and the second individual.

51. The system of claim 48, wherein means for receiving the epigenetic information for a second individual comprises:
means for receiving a first set of the epigenetic information associated with the personally identifying information; and
means for receiving a second set of the epigenetic information associated with the personally identifying information.

52. The system of claim 51, further comprising:
means for receiving a third set of the epigenetic information associated with the personally identifying information.

53. The system of claim 48, wherein means for receiving the epigenetic information for a second individual comprises:
means for receiving information including a cytosine methylation status of CpG positions.

54. The system of claim 48, wherein means for receiving the epigenetic information for a second individual comprises:
means for receiving information including a histone modification status.

55. The system of claim 41, wherein means for receiving epigenetic information including personally identifying information and at least one epigenetic feature of interest associated with the personally identifying information for an individual comprises:
means for receiving the epigenetic information on a subscription basis.

56. The system of claim 41, wherein means for obfuscating the personally identifying information comprises:
means for processing the personally identifying information.

57. The system of claim 56, wherein means for processing the personally identifying information comprises:
modifying at least one of a name, an address, a social security number, a telephone number, an ethnicity, a nationality, a genetic ID, an image, or an age.

58. The system of claim 56, wherein means for processing the personally identifying information comprises:
means for suppressing data cells containing at least one of epigenetic information or personally identifying information.

59. The system of claim 56, wherein means for processing the personally identifying information comprises:
means for binning at least one of the personally identifying information or the epigenetic information.

60. The system of claim 59, wherein means for binning at least one of the personally identifying information or the epigenetic information comprises:
means for establishing a bin identifier.

61. The system of claim 59, wherein means for binning at least one of the personally identifying information or the epigenetic information comprises:
means for transforming real data into categorical data, the categorical data including non-overlapping regions of a continuum.

62. The system of claim 56, wherein means for processing the personally identifying information comprises:
means for processing an algorithm.

63. The system of claim 62, wherein means for processing an algorithm comprises:
means for processing a k-anonymity algorithm.

64. The system of claim 63, wherein means for processing a k-anonymity algorithm comprises:
means for processing 1-diversity coupled with the k-anonymity algorithm.

65. The system of claim 62, wherein means for processing an algorithm comprises:
means for processing an Incognito algorithm.

66. The system of claim 62, wherein means for processing an algorithm comprises:
means for processing an ambiguation algorithm.

67. The system of claim 41 wherein means for obfuscating the personally identifying information comprises:
means for generalizing at least a portion of the personally identifying information.

68. The system of claim 41, wherein means for obfuscating the personally identifying information comprises:
means for removing at least a portion of the personally identifying information.

69. The system of claim 41, wherein means for obfuscating the personally identifying information comprises:
means for substituting at least a portion of the personally identifying information.

70. The system of claim 69, wherein means for substituting at least a portion of the personally identifying information comprises:
means for integrating a pseudonym.

71. The system of claim 69, wherein means for substituting at least a portion of the personally identifying information comprises:
means for replacing personally identifying information with an anonymous identifier.

72. The system of claim 41, wherein means for obfuscating the personally identifying information comprises:
means for encrypting the personally identifying information.

73. The system of claim 72, wherein means for encrypting the personally identifying information comprises:
means for applying symmetric-key cryptography.

74. The system of claim 73, wherein means for applying symmetric-key cryptography comprises:
means for applying a block cipher.

75. The system of claim 73, wherein means for applying symmetric-key cryptography comprises:
means for applying a stream cipher.

76. The system of claim 73, wherein means for applying symmetric-key cryptography comprises:
means for applying a message authentication code.

77. The system of claim 73, wherein means for applying symmetric-key cryptography comprises:
means for applying a hash function.

78. The system of claim 77, wherein means for applying a hash function comprises:
means for applying a one-way hash function.

79. The system of claim 77, wherein means for applying a hash function comprises:
means for applying a collision-free hash function.

80. The system of claim 72, wherein means for encrypting the personally identifying information comprises:
means for applying public-key cryptography.

81. A system comprising:
circuitry for receiving epigenetic information including personally identifying information and at least one epigenetic feature of interest associated with the personally identifying information for an individual; and
circuitry for obfuscating the personally identifying information.
